(19) United States
(12) Patent Application Publication
(10) Pub. No.: US 2007/0298808 A1
(43) Pub. Date: Dec. 27, 2007

(54) Managing wireless backhaul communications

(76) Inventors: Vic Pan, Bedminster, NJ (US); Subramanian Vasudevan, Morristown, NJ (US)

Correspondence Address: CARLSON, GASKEY & OLDS, P.C., 400 W MAPLE RD, SUITE 350, BIRMINGHAM, MI, 48009, US

(21) Appl. No.: 11/475,511

(22) Filed: Jun. 27, 2006

(51) Int. Cl. H04Q 7/20

(52) U.S. Cl. 455/452.1

(57) ABSTRACT

A wireless communication system is disclosed where a hub base station has an associated scheduler. Remotely located subscriber stations such as customer premises equipment devices each have their own associated scheduler in the vicinity of each device. The hub base station scheduler is responsible for scheduling communications in a first direction between the hub base station and the subscriber stations. Each subscriber station scheduler is responsible for scheduling communications in a second, opposite direction between the corresponding subscriber station and the hub base station. In one example, the schedulers associated with the subscriber stations are responsible for scheduling all backhaul or uplink communications from the subscriber station to the base station. A disclosed example is useful for WiMax communications.

### FIELD OF THE INVENTION

This invention generally relates to communication. More particularly, this invention relates to wireless communications.

### DESCRIPTION OF THE RELATED ART

Wireless communication systems are well known. Various types of wireless communications are currently available. One type of communication that is currently under development is referred to as WiMax. In a typical WiMax communication system, a WiMax hub base station transceiver system (BTS) communicates with a plurality of customer premises equipment (CPE) devices that are located remotely from the WiMax hub BTS. In many instances, the CPE allows for one or more users within a building, for example, to communicate via the over-the-air interface between the CPE and the WiMax hub BTS.

Various developments are underway for improving the capabilities of WiMax communications. There are several areas in which improvement is needed. One shortcoming or drawback associated with the current WiMax configuration is that undesirable delay is introduced particularly for backhaul communications in a direction from the CPE to the WiMax hub BTS and the network with which the WiMax hub BTS communicates. The undesirable delay is the result of typical WiMax scheduling algorithms.

WiMax systems currently support four service classes including unsolicited grant, real time polling, non-real time polling and best effort classes. Unsolicited grant service (UGS) communications are intended for very low latency applications. WiMax UGS communications are intended to emulate E1 or T1 type communication links and are meant to provide Time Division Multiplexing (TDM) type delay and traffic capacity performance. For the best effort service, latency is not critical. Typical WiMax configurations include scheduling other services ahead of best effort because the other services have a higher priority. Whenever there is nothing else to send, best effort traffic can then be sent to attempt to maximize overall traffic capacity. Within any given mix of the four services or types of traffic, there is a trade off between traffic capacity and delay among users and the different traffic classes.

Two aspects of WiMax performance include the maximum sustained traffic rate (MSTR) and the minimum reserved traffic rate (MRTR) on the uplinks between the CPEs and the WiMax hub BTS. These parameter values are used in a scheduling algorithm to limit the amount of traffic that can be transmitted at one time and to guarantee a minimum service traffic rate for each user service class. For example, a MRTR for a best effort user protects that user from being completely shut out of service during periods of high traffic. The aggregate MSTR places an upper bound on the amount of incoming traffic. Based upon the aggregate MSTR, a scheduler at the WiMax hub BTS can determine how many users may be scheduled ahead of other lower priority users while still being able to catch up while maintaining the MRTR of all users and all traffic classes.

The MRTR for a CPE is typically set lower than the MSTR. Issuing fewer grants to a CPE than the MSTR allows for recouping lost traffic capacity when there is nothing to send on the UGS link. Such available capacity can be used to service other user classes, for example. When necessary, a handshaking technique allows for a CPE to request more grants.

The WiMax hub BTS scheduler manages the uplink and downlink traffic between the WiMax hub BTS and all CPEs in communication with that BTS. Typical WiMax transmit and request policy prohibits a CPE from using any contention requests on the uplink. A CPE must use a slip indicator (SI) within a WiMax air frame to signal the WiMax BTS that the CPE's service queue depth threshold is exceeded and to request more grants from the WiMax BTS so that the CPE may attempt to empty its transmission queue. Accordingly, the CPE uses a handshaking technique involving the exchange of air frames with the WiMax hub BTS to acquire and utilize uplink bandwidth. This handshaking technique introduces undesirable latency.

During the time an airframe is being filled, a CPE may determine that the transmit queue depth threshold at the CPE is exceeded. During the next airframe, the CPE flags the SI to signal the WiMax hub BTS to issue another grant to that CPE. On the next airframe (i.e., five milliseconds later) the grant is received. The queue at that CPE can then be drained on the next airframe (i.e., another five milliseconds later). The overall delay of this handshaking exchange usually involves four air frames plus some processing time on the order of one or two milliseconds. In such an example, the overall delay associated with the handshaking technique can be more than twenty milliseconds.

Such a delay has limited the availability of WiMax communications for certain types of latency sensitive communications. For example, backhaul in a CDMA or UMTS 2G/3G cell site for soft handoff requires a much smaller delay than the 20 milliseconds typically needed for backhaul handshaking in a WiMax configuration.

There is a need for improved communication within a WiMax system for at least minimizing delay associated with backhaul communications. This invention addresses such needs.

### SUMMARY OF THE INVENTION

An exemplary method of communicating between a hub base station having a hub scheduler and at least one subscriber device having its own scheduler includes processing communications in the first direction between the hub base station and the subscriber device responsive to operation of the hub scheduler. Communications in a second, opposite direction between the hub base station and the subscriber device are processed responsive to operation of the subscriber device scheduler.

In one example, the communications in the first direction are those that occur in a downlink direction from the hub base station to the customer premises equipment. The communications in the second direction are those in an uplink direction from the customer premises equipment to the hub base station.

Approaching scheduling in the example manner allows for scheduling all downlink communications at the hub base station. All uplink communications can be scheduled at the subscriber station. Such an approach eliminates the requirement for handshaking as described above. Delays can be minimized and the availability of communications using such a hub base station and subscriber station can be significantly expanded.

An example communication device includes a subscriber station for facilitating wireless communications on behalf of at least one user by communicating with a remotely located hub base station. A scheduler is associated with the subscriber station in a vicinity of the subscriber station for scheduling communications in a direction from the subscriber station to the hub base station.

In one example, a base station is associated with the subscriber station and the scheduler. The base station is located in the vicinity of the subscriber station. The base station is useful for transmitting the communications scheduled by the subscriber station scheduler.

In one example, the subscriber station comprises WiMax customer premises equipment and includes a receiver for receiving communications scheduled by a scheduler associated with the hub base station.

An example communication system for wireless communications includes a hub base station that has a hub scheduler. At least one remotely located subscriber station is capable of receiving communications from the hub base station. All communications transmitted by the hub base station are scheduled by the hub scheduler. The subscriber station includes its own scheduler that schedules all communications from the subscriber station to the hub base station.

In one example, the subscriber station includes its own base station for transmitting communications to the hub base station. In such an example, the hub base station includes its own subscriber station receiver capabilities for receiving communications from the subscriber station base station.

The various features and advantages of this invention will become apparent to those skilled in the art from the following detailed description. The drawings that accompany the detailed description can be briefly described as follows.

### BRIEF DESCRIPTION OF THE DRAWINGS

FIG. 1 schematically illustrates selected portions of a wireless communication system that is useful with an embodiment of this invention.

FIG. 2 is a flowchart diagram summarizing one example approach.

### DETAILED DESCRIPTION

A disclosed example embodiment of this invention provides for scheduling transmissions in a first direction between a hub base station and a subscriber station such as customer premises equipment using one scheduler associated with the hub base station. Communications in a second, opposite direction between the hub base station and the subscriber station is scheduled by another scheduler associated with the subscriber station. Using two different schedulers for the two different directions of communication reduces communication delays, at least in part, because it eliminates any requirement for handshaking between the subscriber station and the hub base station as was used in arrangements where the hub base station scheduler was responsible for scheduling all communications in both directions.

The example embodiment represents a significant departure from previous communication arrangements such as those used for WiMax communications, for example, where a hub base station scheduler was responsible for scheduling all communications in both directions between the hub base station and remotely located subscriber stations or customer premises equipment. This example utilizes one scheduler for controlling communications in one direction while utilizing another scheduler for controlling communications in a second, opposite direction.

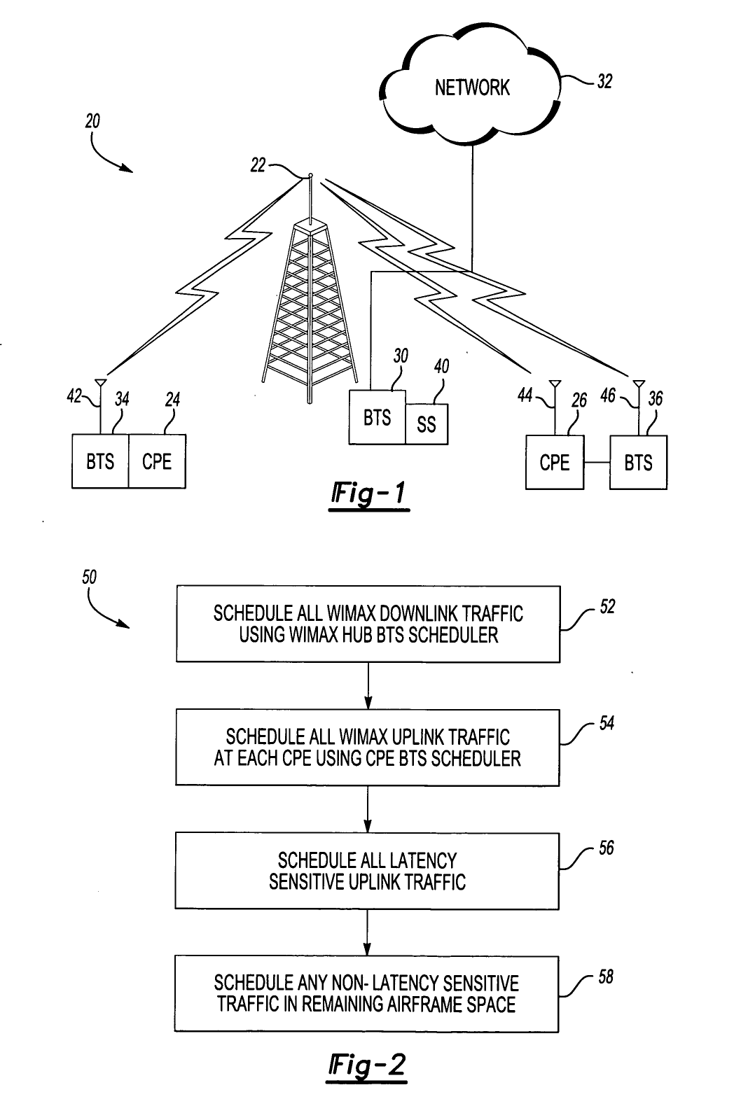

FIG. 1 schematically illustrates selected portions of one example wireless communication system 20. A hub base station transceiver system (BTS) 22 includes known radio tower equipment for communicating over an air interface using wirelessly transmitted signals in a generally known manner. In the illustrated example, the hub BTS 22 is useful for WiMax communications.

A plurality of subscriber stations are within a communication range of the hub BTS 22. The illustration includes example subscriber stations 24 and 26. In this example, the subscriber stations 24 and 26 comprise customer premises equipment devices (CPEs) that are useful with WiMax communications. The CPEs 24 and 26 are located remotely from each other and the hub BTS 22.

The hub BTS 22 includes a controller portion 30 that controls communications between the hub BTS 22 and a communication network 32 in a known manner. The BTS controller 30 also includes a scheduler that uses a known scheduling algorithm in one example.

The scheduler of the BTS controller 30 in this example schedules all communications in a first direction between the hub BTS 22 and any of the CPEs with which the hub BTS 22 communicates.

Each CPE in the illustrated example has its own scheduler portion associated with the CPE. In this example, the CPE 24 has an associated base station portion 34 that includes a base station scheduler that uses a known scheduling algorithm. The CPE 26 has an associated base station 36 that includes its own scheduler. In the illustrated example, the base station portion 34 of the CPE 24 is integrated with the CPE components as schematically shown. In the case of the CPE 26, the base station 36 comprises separate components that are appropriately linked with the CPE 26 and located within close proximity to or the vicinity of the CPE 26. Given this description, those skilled in the art will realize how to arrange components to meet the needs of their particular situation.

The schedulers at each of the CPEs schedule all communications in a second direction that is opposite from the first direction between the hub BTS 22 and the corresponding CPE. For example, the scheduler associated with the base station 34 at the CPE 24 schedules all communications in the second direction between the hub BTS 22 and the CPE 24. Similarly, the scheduler associated with the base station 36 of the CPE 26 schedules all communications in the second direction between the hub BTS 22 and the CPE 26.

In the illustrated example, the hub BTS 22 includes subscriber station capabilities in a subscriber station module 40 that is configured to receive communications transmitted by the base stations associated with the CPEs. In this example, the communications from the CPEs 24 and 26 to the hub BTS 22 may be regarded as uplink communications between the CPEs and the hub BTS 22. Because a base station is used for such communications in this example, communications from the base stations 34 or 36 to the hub BTS 22 and more particularly, the subscriber station module 40 can also be considered “downlink” communications because they technically are occurring between a base station and a subscriber station module.

In this example, the first direction communications that are scheduled by the scheduler of the hub BTS 22 are those communications occurring in the direction from the hub BTS 22 to the CPEs 24 or 26. Accordingly, the CPE 24 and the CPE 26 each include receiver portions for receiving such communications. The second direction of communication in this example is from the CPEs 24 or 26 to the hub BTS 22. More particularly, in the illustrated example, the commutations in the second direction are transmitted by the base stations 34 or 36 associated with the CPEs 24 and 26, respectively, to the hub BTS 22.

In the illustration, the CPE 24 and the base station 34 share an antenna 42 for receiving communications in the first direction and transmitting communications in the second direction. The CPE 26 has a dedicated antenna 44 for receiving communications in the first direction while the base station 36 has a dedicated antenna 46 for transmitting communications in the second direction. Given this description, those skilled in the art will be able to arrange components to meet the needs of their particular situation.

Using different schedulers at the different locations allows for removing any need for handshaking to achieve the “uplink” capacity needed for each CPE. Instead, with the disclosed example, each end point can dynamically schedule unsolicited grant service (UGS) and non-UGS traffic without the traffic waste associated with configurations where a hub base station scheduler was responsible for scheduling communications in both directions. For example, if a UGS service has nothing to send, the scheduler can fill an airframe with non-UGS data. Conversely, whenever there is UTS data to send by a user, that data can be immediately sent on the current airframe, which minimizes latency. The base station schedulers on each end of the link (e.g., at the hub BTS and the subscriber station) eliminates protocol handshaking that was otherwise needed for achieving more bandwidth. The latency on each link is in this example, approximately the duration of an airframe plus processing time such as one or two milliseconds. If a typical airframe size of five milliseconds were used, the latency is now on the order of five or six milliseconds, which greatly expands the capability of the example communication system compared to the prior arrangements already described.

In one example, the frequency configuration includes Time Division Duplexing with nearly all of the airframe allocated in the CPE to hub BTS direction (e.g., the second direction). In one example, 90% or 95% of the airframe allocation is for the second direction. In one example, the minimum reserved traffic rate for WiMax communications is set below the maximum sustained traffic rate.

The end points (e.g., the hub BTS 22 and the CPEs 24 and 26, respectively) are connected using two half duplex “downlink” wireless connections scheduled by the base station at each location for the corresponding direction of communication.

FIG. 2 includes a flowchart diagram 50 that summarizes one example approach. In this example, as shown at 52, all downlink traffic is scheduled using a hub base station scheduler (e.g., the hub BTS 22 scheduler). As shown at 54, all uplink traffic (e.g., in an opposite direction compared to the traffic scheduled at 52) for each subscriber station or CPE is scheduled using a base station scheduler associated with the subscriber station. In the example of FIG. 2, as shown at 56, all latency sensitive traffic is scheduled first on the uplink. Any non-latency sensitive traffic is scheduled within any remaining airframe space at 58. This approach allows for servicing the different service classes commonly used in WiMax communications, for example.

Given this description, those skilled in the art will realize that various modifications to the disclosed example are possible including expanding the capabilities of the system in a variety of ways. For example, it may be useful to apply the various features of the disclosed example to communications other than WiMax communications.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

We claim:

1. A method of communicating between a hub base station having a hub scheduler and at least one remotely located subscriber station having a subscriber station scheduler, comprising the steps of:
processing communications in a first direction between the hub base station and the subscriber station responsive to operation of the hub scheduler; and
processing communications in a second, opposite direction between the hub base station and the subscriber station responsive to operation of the subscriber station scheduler.

2. The method of claim 1, wherein the first direction is from the hub base station to the subscriber station; and
the second direction is from the subscriber station to the hub base station.

3. The method of claim 1, comprising
exclusively scheduling communications in the first direction using the hub scheduler.

4. The method of claim 3, comprising
exclusively scheduling communications in the first direction between the hub base station and any subscriber station in communication with the hub base station.

5. The method of claim 1, comprising
receiving at least one communication in the second direction at the hub base station.

6. The method of claim 5, comprising
providing subscriber station capabilities at the hub base station for the receiving.

7. The method of claim 1, comprising
exclusively scheduling communications in the second direction using the subscriber station scheduler.

8. The method of claim 1, comprising
scheduling all latency sensitive traffic first in at least one of the first or second directions; and
using any remaining airframe capacity for scheduling non-latency sensitive traffic in the at least one of the directions.

9. The method of claim 1, comprising
operating in a half-duplex mode in at least one of the first or second directions.

10. The method of claim 9, comprising
operating in the half-duplex mode in both the first and second directions.

11. The method of claim 1, wherein the communications in the first and second directions comprise WiMax communications.

12. The method of claim 11, wherein the subscriber station comprises customer premises equipment that facilitates communications on behalf of a plurality of users.

13. A wireless communication device, comprising:
a subscriber station for facilitating wireless communications on behalf of at least one user and a hub base station located remotely from the subscriber station; and
a subscriber station scheduler associated with the subscriber station in a vicinity of the subscriber station for scheduling communications from the subscriber station to the hub base station.

14. The device of claim 13, comprising
a base station in the vicinity of the subscriber station for transmitting communications scheduled by the subscriber station scheduler.

15. The device of claim 13, wherein the subscriber station includes a receiver for receiving communications scheduled and transmitted by the hub base station.

16. The device of claim 13, wherein the wireless communications comprise WiMax communications and the subscriber station comprises customer premises equipment for facilitating communications on behalf of a plurality of users.

17. A wireless communication system comprising:
a hub base station;
a hub scheduler associated with and located in the vicinity of the hub base station;
at least one remotely located subscriber station; and
a subscriber station scheduler associated with and located in the vicinity of the subscriber station, the hub scheduler scheduling communications between the hub base station and the subscriber station in a first direction and the subscriber station scheduler scheduling communications between the hub base station and the subscriber station in a second, opposite direction.

18. The system of claim 17, comprising
a base station associated with and located in the vicinity of the subscriber station for transmitting communications scheduled by the subscriber station scheduler.

19. The system of claim 17, wherein the hub scheduler schedules all transmissions in the direction from the hub base station to the subscriber station; and
the subscriber station scheduler schedules all transmissions in the direction from the subscriber station to the hub base station.

20. The system of claim 17, wherein the hub base station and the subscriber station communicate using WiMax communications.
